(19) United States
(12) Patent Application Publication
(10) Pub. No.: US 2022/0316275 A1
(43) Pub. Date: Oct. 6, 2022

(54) LADDER STABILIZATION ASSEMBLY, SYSTEM, AND METHOD OF USING THE SAME

(71) Applicant: Kelly Currie, Russell, IA (US)

(72) Inventor: Kelly Currie, Russell, IA (US)

(21) Appl. No.: 17/712,847

(22) Filed: Apr. 4, 2022

Related U.S. Application Data
(60) Provisional application No. 63/170,034, filed on Apr. 2, 2021.

(51) Int. Cl. E06C 7/46

(52) U.S. Cl. CPC E06C 7/46

(57) ABSTRACT

The disclosure provided herein is directed to a ladder stabilizer assembly. The ladder stabilizer assembly comprises cross bars that are each configured to be positioned on opposing sides of a rung of a ladder. The ladder stabilizer assembly also comprises a first stake and a second stake that are connected the cross bars. In some aspects, a third stake is connected to one of the cross bars.

### CROSS REFERENCE TO RELATED APPLICATION

This application claims the benefit U.S. Provisional Application Ser. No. 63/170,034 filed Apr. 2, 2021, the contents of this application is hereby incorporated by reference in their entirety.

### BACKGROUND OF THE INVENTION

This disclosure generally relates to a ladder stabilizer. More specifically, and without limitation, this invention relates to a ladder stabilizer assembly to physically secure a ladder to a ground surface.

Ladders and devices to stabilize ladders are well known in the art. Injuries from ladders, however, continue to be a significant problem. According to the World Health Organization, each year more than 300 deaths occur in the U.S. as the result of individuals falling from ladders. Falling ten feet or less from a ladder can result in death and it is unsurprising that falls from ladders continues to be a leading cause of death on construction sites. While annual numbers vary, it is not unheard of for more than 150,000 injuries to occur annually in the U.S. that require an emergency room visit for treatment, while hundreds of thousands more require medical treatment.

To address the risks associated with using a ladder, a number of advancements have taken place. One example is the use of a ladder level, which is an extension attached to the bottom of a ladder's side rails to provide stability on an uneven ground surface. While useful, the application of the device is not universal and in general, it is advisable to place a ladder on a level surface. Such devices also have the drawback of being essentially without utility in the event that an individual loses their balance and topple from the ladder as the ladder shifts with the individual's weight.

Another related advancement is the use of a telescoping pin that extends from the side rails. Like level ladders, the usefulness of such devices is limited and their use promotes dangerous positioning of a ladder. Furthermore, such telescoping pins are known to fault, resulting in harm.

Other advancements have taken place to stabilize ladders. These include the use of stabilizer arms that are generally U-shaped and attached near the top of a ladder. Such devices enhance stability of the ladder, but significant jarring of the ladder like that caused by an individual losing their balance can still result in the ladder, and the individual, falling as the ladder teeters under the shifting weight of the individual. Additionally, if an individual loses their balance and pulls on the ladder to regain their balance, it is possible that the individual can pull the ladder backwards so that the ladder falls on top of the individual, enhancing the degree of injury.

Considering the deficiencies present in the art, it is a primary objective of this invention to provide a ladder stabilizer assembly and system that improves upon the art.

Another aspect of this invention is to provide a ladder stabilizer assembly that works with a variety of ladder types.

Yet another aspect of this invention is to provide a ladder stabilizer assembly that anchors a ladder in place.

Another aspect of this invention is to provide a ladder stabilizer assembly that increases safety of using a ladder, including while alone.

Yet another aspect of this invention is to provide a ladder stabilizer assembly that resists rocking and pulling.

Another aspect of this invention is to provide a ladder stabilizer assembly that is easy to transport and store.

Yet another aspect of this invention is to provide a ladder stabilizer assembly that is removable from a ladder.

Another aspect of this invention is to provide a ladder stabilizer assembly that is easy to use.

These and other aspects, features, and advantages of the invention will become apparent from the specification and claims.

### SUMMARY OF THE INVENTION

The disclosure provides various aspects of a ladder stabilizer assembly.

In some aspects, broadly described herein, the techniques described relate to a ladder stabilizer including: a first stake connected to a first end of a first cross bar and a first end of a second cross bar; a second stake connected to a second end of the first cross bar and a second end of a second cross bar; and a third stake connected to the second cross bar between the first end and the second end of the second cross bar.

In some aspects, broadly described herein, the techniques described relate to a ladder stabilizer assembly wherein the first cross bar and the second cross bar are parallelly spaced with respect to one another.

In some aspects, broadly described herein, the techniques described relate to a ladder stabilizer assembly wherein the first cross bar and the second cross bar are configured to extend a distance that is less than distance between a first side rail and a second side rail of a ladder.

In some aspects, broadly described herein, the techniques described relate to a ladder stabilizer assembly wherein the first cross bar has a planar shape having an elongated rectangular profile in a horizontal orientation during operation.

In some aspects, broadly described herein, the techniques described relate to a ladder stabilizer assembly wherein the first stake has a hook shape including a curved portion and straight portion.

In some aspects, broadly described herein, the techniques described relate to a ladder stabilizer assembly wherein the curved portion extends from a first terminal end to the straight portion, and the straight portion extends from the curved portion to a second terminal end.

In some aspects, broadly described herein, the techniques described relate to a ladder stabilizer assembly wherein the first stake is connected flush with a first terminal end of the first cross bar and a first terminal end of the second cross bar.

In some aspects, broadly described herein, the techniques described relate to a ladder stabilizer assembly wherein the second bar connects to the first stake abutting a first terminal end of the first stake and the first cross bar connects to the first stake abutting a transition of the first stake from a curved portion to a straight portion.

In some aspects, broadly described herein, the techniques described relate to a ladder stabilizer assembly wherein the first stake is connected to an interior surface of the first cross bar and an interior surface of the second cross bar.

In some aspects, broadly described herein, the techniques described relate to a ladder stabilizer assembly wherein the third stake is connected to the second cross bar near a midpoint of the second cross bar in relation to the first end and the second end of the second cross bar.

In some aspects, broadly described herein, the techniques described relate to a ladder stabilizer assembly wherein the third stake is connected to the second cross without a first terminal end of the third stake not extending beyond a height of the second cross bar.

In some aspects, broadly described herein, the techniques described relate to a ladder stabilizer assembly wherein the third stake is connected to an exterior surface of the second cross bar.

In some aspects, broadly described herein, the techniques described relate to a ladder stabilizer assembly wherein the first stake, the second stake, and the third stake are at least partially inclusive of a material having protrusions.

In some aspects, broadly described herein, the techniques described relate to a ladder stabilizer assembly wherein the first stake, the second stake, the third stake, the first cross bar, and the second cross bar are of a monolithic construction such that a single continuous body is formed.

In some aspects, broadly described herein, the techniques described relate to a ladder stabilizer assembly wherein when inserted into a ground surface the first cross bar and the second cross bar engage a ground surface and a curved portion of the first stake and a curved portion of the second stake are in physical engagement with a rung of a ladder.

This has outlined, rather broadly, the features, advantages, solutions, and benefits of the disclosure in order that the description that follows may be better understood. Additional features, advantages, solutions, and benefits of the disclosure will be described in the following. It should be appreciated by those skilled in the art that this disclosure may be readily utilized as a basis for modifying or designing other structures and related operations for carrying out the same purposes of the present disclosure. It should also be realized by those skilled in the art that such equivalent constructions and related operation do not depart from the teachings of the disclosure as set forth in the appended claims. The novel features, together with further objects and advantages, will be better understood from the following description when considered in connection with the accompanying Figures. It is to be expressly understood, however, that each of the Figures is provided for the purpose of illustration and description only and is not intended as a definition of the limits of the present disclosure.

### BRIEF DESCRIPTION OF THE DRAWINGS

FIG. 1 is a perspective view of a ladder known in the art;

FIG. 2 is a front perspective view of a ladder stabilizer assembly according to an aspect of the disclosure;

FIG. 3 is a rear perspective view of a ladder stabilizer assembly according to an aspect of the disclosure;

FIG. 4 is a front view of a ladder stabilizer assembly according to an aspect of the disclosure;

FIG. 5 is a front view of a ladder stabilizer assembly according to an aspect of the disclosure;

FIG. 6 is a side view of a ladder stabilizer assembly according to an aspect of the disclosure; and

FIG. 7 is a top view of a ladder stabilizer assembly according to an aspect of the disclosure.

### DETAILED DESCRIPTION

The disclosure described herein is directed to different aspects of a ladder stabilizer assembly. The detailed description set forth below, in connection with the appended drawings, is intended as a description of various configurations and is not intended to represent the only configurations in which the concepts described herein may be practiced. These descriptions include specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The disclosure is described herein with reference to certain aspects, iterations, embodiments, and examples but it is understood that the disclosure can be embodied in many different forms and should not be construed as limited to the aspects set forth herein.

Although the terms first, second, etc. may be used herein to describe various elements or components, these elements or components should not be limited by these terms. These terms are only used to distinguish one element or component from another. Hence, a first element discussed herein could be termed a second element without departing from the teachings of the present application. It is understood that actual systems or fixtures embodying the disclosure can be arranged in many different ways with many more features and elements beyond what is shown in the drawings. For the same or similar elements or features, the same reference numbers may be used throughout the disclosure.

It is to be understood that when an element or component is referred to as being “on” another element or component, it can be directly on the other element or intervening elements may also be present. Furthermore, relative terms such as “between”, “within”, “below”, and similar terms, may be used herein to describe a relationship of one element or component to another. It is understood that these terms are intended to encompass different orientations of the disclosure in addition to the orientation depicted in the figures.

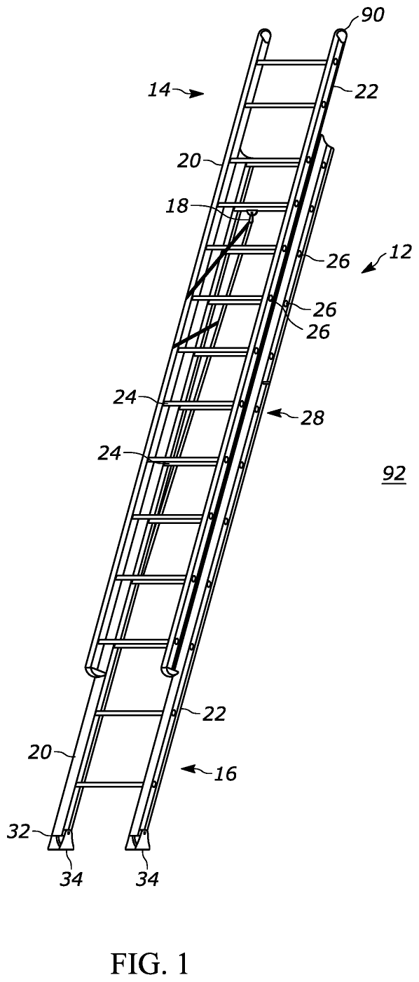

With reference to the Figures aspects of a ladder stabilizer assembly 10 for use in a system with a ladder 12 are shown according to the disclosure. While the present description discusses use of the ladder stabilizer assembly 10 being used with an extension style type of ladder 12, other types of ladders 12 fall within the scope and spirit of the present invention, including a step ladder, single ladder, articulated ladder, tripod ladder, trestle ladder, and telescoping ladder. Though the particular features of the ladder 12 may vary depending on type, the ladder 12 provided for in the present application and seen in FIG. 1 has a fly section 14 and base section 16, which are operatively connected to one another, such as by a rope and pulley system 18, so that the fly section 14 can be raised and lowered in relation to the base section 16 so that an individual can select the overall height of the ladder 12.

Both the fly section 14 and the base section 16 of the ladder 12 have a first side rail 20 and a second side rail 22 with a plurality of steps or rungs 24 extending therebetween. The plurality of rungs 24 are hollow and the first side rail 20 and the second side rail 22 of both the fly section 14 and the base section 16 have openings 26 where each rung 24 connects to the between the first side rail 20 and the second side rail 22. In this way, an enclosed passageway 28 extends through each of the rungs 24 and the first side rail 20 and the second side rail 22.

Some aspects of the ladder 12 include a rung lock 30 (not shown) to prevent the fly section 14 from collapsing when extended in relation to the base section 16. Attached to the bottom terminal end 32 of each of the first side rail 20 and the second side rail 22 of the base section 16 is a safety foot or anti-slip shoe 34.

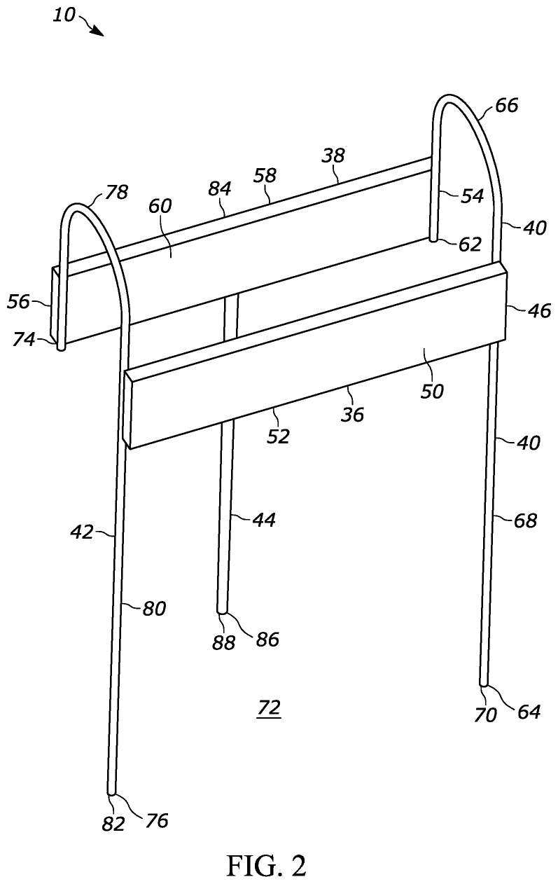

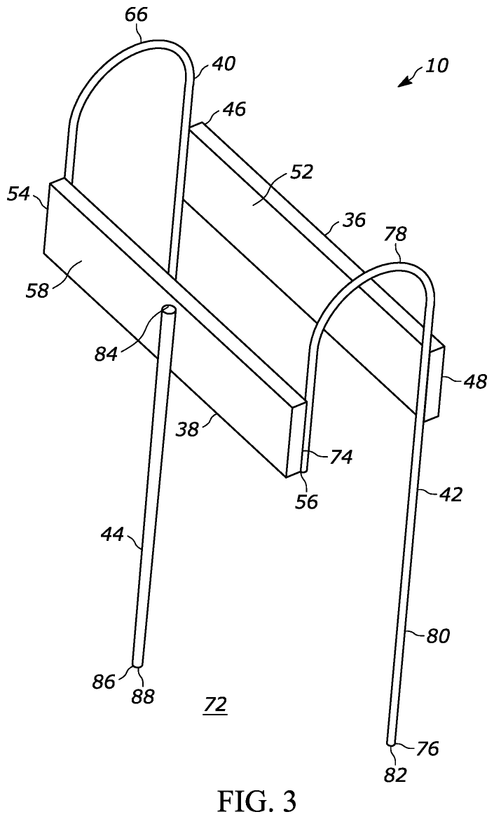

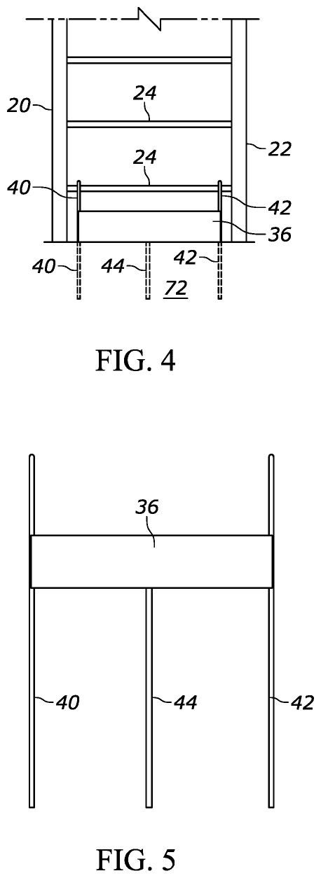

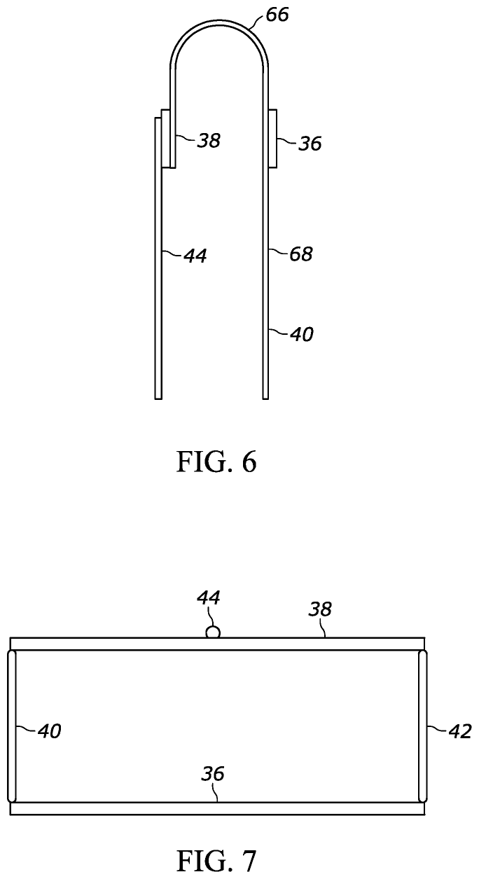

As shown in FIGS. 2-7, the ladder stabilizer assembly 10 comprises a first or front cross bar or plate 36 and a second or rear cross bar or plate 38 that are connected to a first stake 40, a second stake 42, and in some aspects of the present invention, a third stake 44 connected to either the first cross bar 36 or the second cross bar 38. In particular aspects, the first cross bar 36 and the second cross bar 38 are parallelly spaced and/or in parallel spaced alignment. In some aspects, the first cross bar 36 extends from and between a first or one terminal end 46 to a second or opposing terminal end 48 and has a first or exterior surface 50 and a second or interior surface 52. In other aspects, the second cross bar 38 extends from and between a first or one terminal end 54 to a second or opposing terminal end 56 and has a first or exterior surface 58 and a second or interior surface 60. The first cross bar 36 and the second cross bar 38 are sized and shaped to extend a distance that is less than the distance between the first side rail 20 and second side rail 22 of the ladder 12, which facilitates operation of the ladder stabilizer assembly 10 as described further herein. In some aspects, the first cross bar 36 and the second cross bar 38 have a thin and planar shape with a height that is substantially larger than the depth and substantially smaller than the length such that the first cross bar 36 and the second cross bar 38 have an elongated rectangular profile in a horizontal orientation during operation. In other aspects, the size and shape of the first cross bar 36 and the second cross bar 38 are identical or substantially identical to one another.

In further aspects of the present invention, the first stake 40 extends from and between a first or one terminal end 62 to a second or opposing terminal end 64. The first stake 40, in some embodiments, has a cane or hook shape that resembles an upside down “J”, which assists with insertion, removal and stabilization described further herein as well as allowing for a variety of storage arrangements including hanging the ladder stabilizer assembly 10 by the curvature of the first stake 40. Additionally, in this configuration, the top of the first stake 40 can be grasped without encountering any sharp corners that could lead to harm or discomfort upon contact. In aspects of the present invention comprising a cane shaped configuration as well as other embodiments, a curved or U-shaped portion 66 extends from and between the first terminal end 62 to a shaft or straight portion 68 that extends from the curved portion 66 to the second terminal end. In some aspects, the straight portion 68 is configured to converge in a point 70, which facilitates breaking a ground surface 72 during insertion as described further herein.

In other aspects, the second stake 42 extends from and between a first or one terminal end 74 to a second or opposing terminal end 76. The second stake 42, in some embodiments, has a cane or hook shape that resembles an upside down “J”, which assists with insertion, removal and stabilization described further herein as well as allowing for a variety of storage arrangements including hanging the ladder stabilizer assembly 10 by the curvature of the second stake 42. Additionally, in this configuration, the top of the second stake 42 can be grasped without encountering any sharp corners that could lead to harm or discomfort upon contact. In aspects of the present invention comprising a cane shaped configuration as well as other embodiments, a curved or U-shaped portion 78 extends from and between the first terminal end 74 to a shaft or straight portion 80 that extends from the curved portion 78 to the second terminal end 76. In some aspects, the shaft portion 80 is configured to converge in a point 82, which facilitates breaking a ground surface 72 during insertion as described further herein.

In further aspects, the first stake 40 is connected to the first cross bar 36 at the first terminal end 46 and the second cross bar 38 at the first terminal end 54. At this position, the first stake 40 is flush with or nearly flush with the first cross bar 36 and the second cross bar 38, which not only provides for an appealing aesthetic but reduces the potential for harm caused by an individual rubbing against the first terminal end 46 of the first cross bar 36 or the first terminal end 54 of the second cross bar 38. In other aspects, the second cross bar 38 connects to the first stake 40 abutting to or adjacent the first terminal end 62 and the first cross bar 36 connects to the first stake 40 abutting to or adjacent the transition of the first stake 40 from the curved portion 66 to the straight portion 68. This arrangement prevents the first terminal end 62 of the first stake 40 from extending past the first cross bar 36, which in turn prevents harm that would be caused if the first terminal end 62 of the first stake 40 were to extend below. Additionally, upon insertion, the first cross bar 36 and the second cross bar 38, in some aspects, rest against the ground surface 72 providing additional stability as described herein. In certain configurations, the first stake 40 is connected to the interior surface 52 of the first cross bar 36 and the interior surface 60 of the second cross bar 38. This provides the advantages of simplifying assembly of the ladder stabilizer assembly 10, providing superior rigidity to the ladder stabilizer assembly 10 than if the connection were to the exterior surface 50 of the first cross bar 36 or the exterior surface 58 of the second cross bar 38 or both, and allows the curved portion 66 to be positioned with closer tolerance to the rung 24 during operation as described further herein.

In other aspects, the second stake 42 is connected to the first cross bar 36 at the second terminal end 48 and the second cross bar 38 at the first terminal end 54. At this position, the second stake 42 is flush with or nearly flush with the first cross bar 36, and the second cross bar 38, which not only provides for an appealing aesthetic but reduces the potential for harm caused by an individual rubbing against the second terminal end 48 of the first cross bar 36 or the second terminal end 56 of the second cross bar 38. In particular aspects of the present invention, the second cross bar 38 connects to the second stake 42 abutting to or adjacent the first terminal end 74 and the first cross bar 36 connects to the second stake 42 abutting to or adjacent the transition of the second stake 42 from the curved portion 78 to the straight portion 68. This arrangement prevents the first terminal end 74 of the second stake 42 from extending past the first cross bar 36, which in turn prevents harm that would be caused if the first terminal end 74 of the second stake 42 were to extend below. Additionally, upon insertion, the first cross bar 36 and the second cross bar 38, in some aspects, rest against the ground surface 72 providing additional stability as described herein. In certain aspects, the second stake 42 is connected to the interior surface 52 of the first cross bar 36 and the interior surface 60 of the second cross bar 38. This provides the advantages of simplifying assembly of the ladder stabilizer assembly 10, providing superior rigidity to the ladder stabilizer assembly 10 than if the connection were to the exterior surface 50 of the first cross bar 36 or the exterior surface 58 of the second cross bar 38 or both, and allows the curved portion 78 to be positioned with closer tolerance to the rung 24 during operation as described further herein.

In aspects of the present invention comprising the third stake 44, the third stake 44 extends from and between a first or one terminal end 84 to a second or opposing terminal end 86 and in some configurations is a substantially straight elongated shaft. The third stake 44, in some aspects, converges in a point 88, which facilitates breaking a ground surface 72 during insertion as described further herein. In further aspects, the third stake 44 is connected to the second cross bar 38 and in some aspects is connected at or substantially near a midpoint of the second cross bar 38, which allows the first stake 40 and the second stake 42 to be used as the primary points at which manual force is applied on the ladder stabilizer assembly 10 during insertion into the ground surface 72 and the manual force is applied in a balanced and equal manner given the substantially equal distance the third stake 44 is from the first stake 40 and the second stake 42. In some aspects, the third stake 44 is connected to the second cross bar 38 in such a way that the first terminal end 84 of the third stake 44 does not extend above the second cross bar 38, which provides the safety benefits described herein with the first stake 40 and the second stake 42 related to harm caused by falling on or grasping portions of the ladder stabilizer assembly 10. In other aspects of the present disclosure, the third stake 44 is connected to the exterior surface 58 of the second cross bar 38. This provides the unique advantage of simplifying use of the ladder stabilizer assembly 10 as the likelihood of the third stake 44 striking the rung 24 of the ladder 12 during operation is eliminated or nearly eliminated in this configuration. The presence of the third stake 44 prevents or inhibits the ladder stabilizer assembly 10 from twisting, bending, or otherwise contorting should a large amount of force be applied to one side of the ladder 12 during use that imparts significant torque on the ladder stabilizer assembly 10. Additionally, the third stake 44 in some aspects is the only stake extending below the second cross bar 38 and therefore is the only stake to directly anchor the second cross bar 38 to the ground surface 72. Accordingly, another advantage by the third stake 44 is limiting and/or preventing the ladder stabilizer assembly 10 from shifting in the direction of the second cross bar 38, which may result in the first stake 40 and the second stake 42 bending thereby reducing the ease of use of the ladder stabilizer assembly 10 and unnecessarily causing wear both of which could present a danger during operation.

In some embodiments, the first stake 40, the second stake 42, and the third stake 44 are made at least partially from rebar or other materials having protrusions or ridges that assist in retaining the first stake 40, the second stake 42, and the third stake 44 in the ground surface 72 after insertion. While various forms of construction are contemplated, in some aspects the ladder stabilizer assembly 10 is of monolithic construction such that the ladder stabilizer assembly 10 is a single continuous body, such as by way of welding that is not readily disassembled. This provides the unique advantage of reducing unnecessary wear on the system and eliminating points of potential movement during operation that could result from other forms of configuration.

In particular embodiments, the first cross bar 36 and the second cross bar 38 each have a total length of 12.0 inches or approximately 12.0 inches with a height of 1.5 inches or approximately 1.5 inches and a thickness of 0.1875 inches or approximately 0.1875 inches. The first stake 40, second stake 42, and third stake 44 are comprised of cylindrical material having a diameter of 0.375 inches or approximately 0.375 inches. The first stake 40 and second stake 42 have an overall height of 18.0 inches or approximately 18.0 inches, whereas, the third stake 44 has an overall height of 15.0 inches or approximately 15.0 inches. The curved portion 66 of the first stake 40 and the curved portion 78 of the second stake 42 each have a height of 5.0 inches or approximately 5.0 inches in relation to the first cross bar 36 and the second cross bar 38, with the space positioned within the curved portion 66 and 78 extending distance of 1.75 inches or approximately 1.75 inches, which provides for limited tolerances between the first stake 40 and the second stake 42 and the rung 24.

During use, the ladder 12 is placed at an angle with the anti-slip shoes 34 or bottom terminal end 32 on the ground surface 72 and a top terminal end 90 of the ladder 12 against a wall or other surface 92. Once the ladder 12 is positioned, the ladder stabilizer assembly 10 is placed over the bottom rung 24 or other lower rung 24 of the ladder 12. This is facilitated by the connection of the third stake 44 on the exterior surface 58 of the second cross bar 38, which provides a larger gap between the third stake 44 and the straight portion 68 of the first stake 40 and the straight portion 80 of second stake 42 on the first cross bar 36. The shape of the first stake 40 and the second stake 42 further facilitates positioning over the rung 24 as neither extend beyond the second cross bar 38.

Once positioned over the rung 24, downward pressure is applied on the curved portion 66 of the first stake 40 and the curved portion 78 of the second stake 42 to drive the straight portion 68 of the first stake 40, the straight portion 80 of the second stake 42, and the third stake 44 through the ground surface 72. When the ground surface 72 engages or nearly engages the first cross bar 36 and the second cross bar 38, the ladder stabilizer assembly 10 is sufficiently inserted into the ground surface 72 and as such, the first cross bar 36 and the second cross bar 38 provide the benefit of indicating sufficient depth has been reached in addition to providing additional rigidity and stability to the ladder stabilizer assembly. The first cross bar 36 and second cross bar 38 also prevent flexing of the first stake 40 and the second stake 42 during insertion as the torque applied is resisted by their presence. To further limit permanently contorting the first stake 40 and the second stake 42, substantially rigid materials, such as various metals, can be used. For instance, in some arrangements, the ladder stabilizer assembly 10 is made of steel.

When the ladder stabilizer assembly 10 is fully inserted, the rung 24 of the ladder 12 is held in place within the curved portion 66 of the first stake 40 and the curved portion 78 of the second stake 42. In particular aspects, the ladder stabilizer assembly 10 is configured such that upon insertion the first cross bar 36 and the second cross bar 38 engage the ground surface 72 and the curved portion 66 of the first stake 40 and the curved portion 78 of the second stake 42 are in physical engagement with the rung 24 of the ladder 12. The ladder 12 can now be used with the anchoring and stabilization provided by the ladder stabilizer assembly 10. This includes limiting the movement the ladder 12 can travel from side to side while staying in engagement with the wall 92 and also limiting the movement the ladder 12 can accomplish away from the wall 106 should the ladder 12 be pulled away when balance is lost by an individual.

When the ladder 12 is no longer being used, the first stake 40 and the second stake 42 are extracted from the ground surface 72 using the curved portion 66 of the first stake 40 and the curved portion 78 of the second stake 42, the use of which facilitates removal and can be accomplished by an individual without the use of other tools. During this same time, the third stake 44 is also extracted from the ground surface 72.

Therefore, a ladder stabilizer assembly 10 has been provided that works with a variety of ladder types, anchors a ladder in place, increases safety of using a ladder, including while alone, resists rocking and pulling, is easy to transport and store, is removable from a ladder, is easy to use and improves upon the art.

From the above discussion and accompanying figures and claims it will be appreciated that the ladder stabilizer assembly 10 offers many advantages over the prior art. It will be appreciated further by those skilled in the art that various other modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application, including reordering or excluding various elements referenced by number, e.g., first, second, etc.

Although the present disclosure and its advantages have been described in detail, it should be understood that various changes, substitutions, modifications, and alterations can be made herein without departing from the technology of the disclosure as defined by the appended claims. The scope of the present application is not intended to be limited to the particular configurations of the process, machine, manufacture, composition of matter, means, methods and steps described in the specification only expressly stated otherwise. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A ladder stabilizer assembly comprising:
a first stake connected to a first end of a first cross bar and a first end of a second cross bar;
a second stake connected to a second end of the first cross bar and a second end of a second cross bar; and
a third stake connected to the second cross bar between the first end and the second end of the second cross bar.

2. The ladder stabilizer assembly of claim 1 wherein the first cross bar and the second cross bar are parallelly spaced with respect to one another.

3. The ladder stabilizer assembly of claim 1 wherein the first cross bar and the second cross bar are configured to extend a distance that is less than distance between a first side rail and a second side rail of a ladder.

4. The ladder stabilizer assembly of claim 1 wherein the first cross bar has a planar shape having an elongated rectangular profile in a horizontal orientation during operation.

5. The ladder stabilizer assembly of claim 1 wherein the first stake has a hook shape comprising a curved portion and straight portion.

6. The ladder stabilizer assembly of claim 5 wherein the curved portion extends from a first terminal end to the straight portion, and the straight portion extends from the curved portion to a second terminal end.

7. The ladder stabilizer assembly of claim 1 wherein the first stake is connected flush with a first terminal end of the first cross bar and a first terminal end of the second cross bar.

8. The ladder stabilizer assembly of claim 1 wherein the second cross bar connects to the first stake abutting a first terminal end of the first stake and the first cross bar connects to the first stake abutting a transition of the first stake from a curved portion to a straight portion.

9. The ladder stabilizer assembly of claim 1 wherein the first stake is connected to an interior surface of the first cross bar and an interior surface of the second cross bar.

10. The ladder stabilizer assembly of claim 1 wherein the third stake is connected to the second cross bar near a midpoint of the second cross bar in relation to the first end and the second end of the second cross bar.

11. The ladder stabilizer assembly of claim 1 wherein the third stake is connected to the second cross bar with a first terminal end of the third stake not extending beyond a height of the second cross bar.

12. The ladder stabilizer assembly of claim 1 wherein the third stake is connected to an exterior surface of the second cross bar.

13. The ladder stabilizer assembly of claim 1 wherein the first stake, the second stake, and the third stake are at least partially comprised of a material having protrusions.

14. The ladder stabilizer assembly of claim 1 wherein the first stake, the second stake, the third stake, the first cross bar, and the second cross bar are of a monolithic construction such that a single continuous body is formed.

15. The ladder stabilizer assembly of claim 1 wherein when inserted into a ground surface the first cross bar and the second cross bar engage a ground surface and a curved portion of the first stake and a curved portion of the second stake are in physical engagement with a rung of a ladder.
